(19) United States
(12) Patent Application Publication
(10) Pub. No.: US 2006/0269369 A1
(43) Pub. Date: Nov. 30, 2006

(54) Portable electro-pneumatic drill apparatus

(75) Inventors: David L. Fritsche, Foristell, MO (US); David N. Nappier, Caseyville, IL (US)

Correspondence Address: THOMPSON COBURN, LLP, ONE US BANK PLAZA, SUITE 3500, ST LOUIS, MO, 63101, US

(73) Assignee: The Boeing Company

(21) Appl. No.: 11/135,969

(22) Filed: May 24, 2005

(51) Int. Cl. B23B 47/34

(52) U.S. Cl. 408/17

(57) ABSTRACT

A portable drill apparatus combines an air motor that drives a drill chuck in rotation, a linear actuator that drives the air motor and the drill chuck in linear reciprocating movements, and an electric motor that operates the linear actuator. The drill chuck, air motor, linear actuator, and electric motor are all connected together, end to end, enabling the apparatus to be easily manually transported and positioned. A separate programmable controller communicates with the electro-pneumatic drill apparatus and controls the operation of the apparatus to perform peck feed drilling on layers of different materials, and power feed drilling to drill and countersink to controlled depths.

### BACKGROUND OF THE INVENTION

(1) Field of the Invention

The present invention pertains to a portable drill apparatus that combines an air motor that drives a drill chuck in rotation, a linear actuator that drives the air motor and the drill chuck in linear reciprocating movements, and an electric motor that operates the linear actuator. The drill chuck, air motor, linear actuator, and electric motor are connected together, end to end, enabling the apparatus to be easily manually transported and positioned. A separate programmable controller communicates with the electro-pneumatic drill apparatus and controls the operation of the apparatus to perform a peck feed drilling process on layers of different materials, or a power feed drilling process to drill and countersink holes into layers of materials to controlled depths.

(2) Description of the Related Art

In the manufacturing of large structural bodies that are required to have a large degree of structural strength, for example in the manufacturing of aircraft, it is often necessary to drill precisely dimensioned fastener holes through multiple layers of materials having different degrees of hardness. For example, it is often necessary to drill through multiple layers of materials that include a combination of hard and soft materials, such as a composite material and titanium, or a composite material and aluminum. In order to prevent the chips of the harder materials produced by the drilling from eroding the softer materials and causing an oversized hole condition, a peck feed drilling process is often employed.

The peck feed drilling process through multiple layers of different types of materials involves controlling incremental movements of the drill bit. The drill bit movement is controlled to drill into a small amount of the material at a time (typically about 0.033 inches), and then to react the drill bit from the drilled hole. The drill bit is retracted back to its starting position to remove the chips of the material drilled from the hole. This “peck” cycle is repeated numerous times, each time drilling the hole a small amount deeper and removing the drilled chips, until the hole is produced completely through the layers of material. This gives a very consistent and precise hole diameter through the multiple layers of material.

Peck feed drilling is a very useful process when drilling multiple layers of different materials. However, prior art apparatus that are available for performing the peck feed drilling process have been a source of numerous problems. Prior art peck feed drilling equipment typically employs a pneumatic air motor that drives a spindle which, in turn, drives the drill bit in rotation. In addition to the first air motor that drives the spindle, a second air motor in the form of an air cylinder and piston is attached to the rear of the first air motor. The second air motor is operative to move the first air motor and the drill bit spindle forwardly in pecking away portions of the drilled hole, and to retract the air motor and drill bit spindle rearwardly after each pecking movement.

An extensive network of pneumatic couplings and hoses is needed to control the rotation of the first air motor and the linear reciprocating movements of the second air motor during the peck feed drilling process. The pneumatic couplings and hoses are a part of an extensive air logic circuit that includes numerous valves, couplings, and air lines that control the drilling rotation of the first air motor and the pecking reciprocating movements of the second air motor. A substantial framework is needed to support the drilling apparatus and the pneumatic air logic circuit that controls the operations of the two air motors.

The complexity of operating the two air motors and controlling the movements of the two air motors through the operation of the numerous valves of the extensive air logic circuit makes it very difficult to adjust the operation of the two air motors to the desired drill process parameters (i.e., the feed rate of the drill bit, the peck rate of the drill bit, the setback for retracting the drill bit, etc.). The complex nature of the two drill motors and their extensive air logic circuit also makes it difficult to repair the motors and air logic circuit, and also contributes to a frequency of malfunctioning of the motors and the air logic circuit during use. Consequently, this type of manufacturing equipment is very expensive to purchase, is very expensive to maintain, and is very expensive to use.

The same problems exist in power feed drilling equipment that is used in drilling holes and producing countersinks in multiple layers of different materials. This type of drilling process requires precise controlling of the feed rate of the drill bit and the countersink cutter to a controlled depth in the different layers of material, controlling the dwelling of the drill and countersink cutter at the controlled depth for a fixed amount of time, and controlling the retraction of the drill and countersink cutter from the drilled hole and countersink. The prior art equipment of this type has also required a complex air logic circuit to control the movements of the drill bit and the countersink cutter and their dwell times. Consequently, this type of prior art pneumatic power feed drilling equipment is also prone to the same types of problems associated with the prior art pneumatic peck feed drilling equipment.

### SUMMARY OF THE INVENTION

The apparatus of the invention overcomes the problems associated with the complex air logic circuits employed in prior art peck feed drilling and power feed drilling equipment by providing a portable electro-pneumatic drill apparatus that uses a programmable linear motion actuator to electronically control the travel of the drill bit spindle and the pneumatic air motor that rotates the spindle.

The portable electro-pneumatic drill apparatus of the invention employs the combination of an air motor and an electric motor in controlling the rotation of a drill bit chuck, and the reciprocating movements of the drill bit chuck. The combination of the air motor and the electric motor provides the apparatus of the invention with a compact construction that is portable and can be easily manually positioned for drilling operations. In addition, the combination of the air motor and the electric motor in the apparatus significantly simplifies the control system required for the apparatus.

The entire construction of the apparatus is made up of known components arranged in the novel combination and configuration. The components of the apparatus are assembled together, end to end, along a center axis of the apparatus, which facilitates the manual portability of the apparatus.

The apparatus is provided with an adjustable drill bit chuck at one end. The chuck is conventional, and is adjustable to securely and removably hold a variety of different size drill bits.

The chuck is supported in the interior of a nosepiece housing. The nosepiece housing basically supports the chuck for rotary movement, and for axial reciprocating movements of the chuck through the nosepiece housing interior.

An air motor housing is connected to the nosepiece housing. The air motor housing has a hollow interior bore that extends axially through the housing.

An air motor is mounted in the air motor housing for axial reciprocating movement of the air motor through the air motor housing interior bore. The air motor is operatively connected to the drill bit chuck and moves in axial reciprocating movements with the drill bit chuck. The air motor has a coupling for connecting the air motor to a separate source of pneumatic pressure. The pneumatic pressure supplied to the air motor controls the operation of the air motor in rotating the drill bit chuck.

A linear actuator housing is connected to the air motor housing. The actuator housing contains a ball and lead screw actuator that is connected to the air motor in the air motor housing. Operation of the linear actuator moves the air motor axially through the interior bore of the air motor housing, and thereby moves the drill bit chuck axially through the interior bore of the nosepiece housing.

An electric motor is connected to the linear actuator housing. The electric motor is operatively connected to the ball and lead screw actuator in the actuator housing. In the preferred embodiment, the electric motor is a hybrid stepper motor. Selective operation of the electric motor controls the linear actuator to move the air motor axially in the air motor housing interior bore, which results in movements of the drill bit chuck axially in the nosepiece housing interior bore.

An optical encoder is connected to the electric motor for monitoring the rotary output of the electric motor. The optical encoder is designed to produce signals representative of degrees of rotation of the electric motor, which are also representative of movements of the linear actuator in the actuator housing, movements of the air motor in the air motor housing, and movements of the drill bit chuck in the nosepiece housing.

A sensor is mounted on the linear actuator housing. In the preferred embodiment, the sensor is a magnetic reed switch. The sensor senses the position of the linear actuator screw in the actuator housing. In particular, the sensor provides signals that are representative of the position of the lead screw in the actuator housing, and thereby determines movement of the lead screw to its fully set back position.

A separate programmable controller communicates with the electric motor, the optical encoder, and the sensor on the actuator housing. The controller is operative to control the operation of the electric motor based on information previously programmed into the controller and information provided by the signals produced by the optical encoder and the sensor. The programmable controller is designed so that a motion profile for the drilling operation to be performed by the apparatus can be programmed on a desk top computer and downloaded to the controller. The controller can then be activated by a push button operated by an individual monitoring the drilling operation of the apparatus. With the apparatus secured at a work station adjacent the object to be drilled, the operator activates the apparatus to execute a peck feed drill cycle or a drill/countersink cycle, according to the preprogrammed motion profile. The controller executes the motion profile by controlling the rotation of the air motor and electric motor, and the resulting rotation of the drill bit chuck and the linear movements of the linear actuator. The controller can execute the motion profile without being connected to an external computer, and the motion profile can be repeated any number of times desired as programmed. Exact feed rates, peck rates, set back distances, stroke lengths, and dwell times can be programmed into the motion profile programmed in the controller, and the controller will control the drilling cycle to repeat itself exactly time after time. The programmed motion profile cannot be changed by the operator, and crib setup personnel simply download the motion profile provided to them into the controller to control the operation of the apparatus. Thus, the apparatus of the invention provides very little chance for human or mechanical errors to occur in the drilling procedures.

The present invention greatly simplifies and improves the reliability of existing peck feed drilling and drill/countersink processes, and makes these processes more practical at manufacturing sights. The present invention provides significant improvements in the cost of manufacturing, the quality of the manufactured product, and the cycle time required for the manufacturing process. Thus, the apparatus of the invention represents an important evolutionary development in the field of portable power feed drilling.

### BRIEF DESCRIPTION OF THE DRAWINGS

Further features of the invention are set forth in the following detailed description of the preferred embodiment of the invention and in the drawing figure wherein:

FIG. 1 shows a schematic representation of the portable electro-pneumatic drill apparatus of the invention.

### DETAILED DESCRIPTION OF THE PREFERRED EMBODIMENT

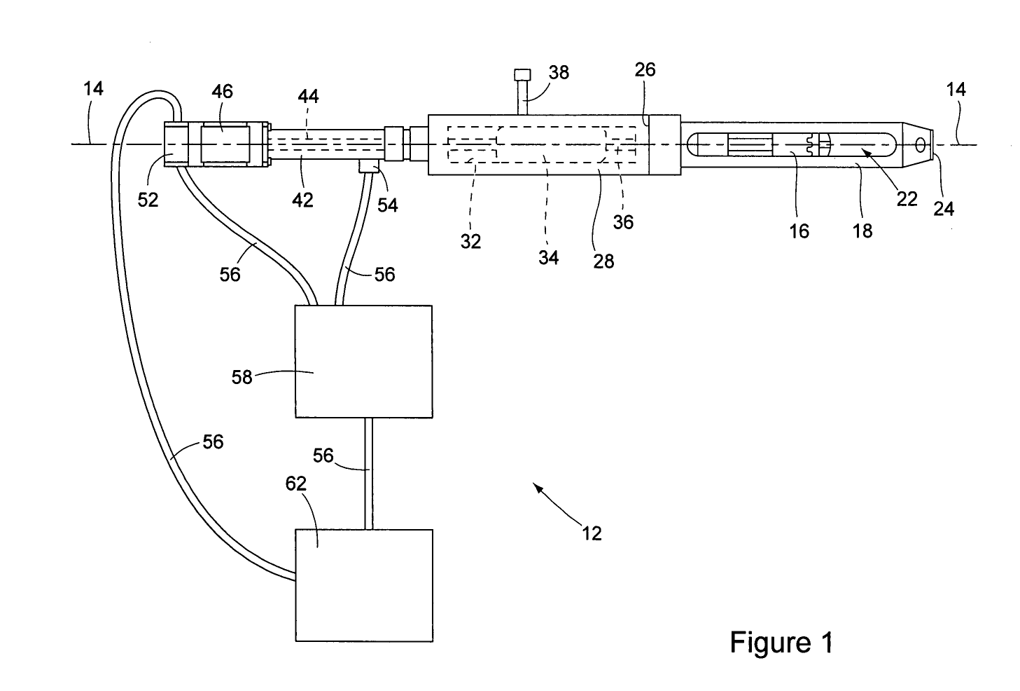

FIG. 1 shows a schematic representation of the portable electrode-pneumatic drill apparatus 12 of the present invention. As stated earlier, the construction of the apparatus 12 is made up of known components arranged in a novel combination and configuration. Because the components are known, they are shown only schematically in FIG. 1. As shown in FIG. 1 and as will be explained, the components of the apparatus 12 are assembled together, end to end, along a center axis 14 of the apparatus 12, which facilitates the manual portability of the apparatus.

The apparatus 12 includes an adjustable drill bit chuck 16 of conventional construction. In the preferred embodiment, the chuck 16 is a 3-jaw chuck that is adjustable to securely hold a variety of different size drill bits. The chuck 16 removably holds the drill bits, allowing replacement of various different size drill bits in the chuck.

A nose piece housing 18 surrounds and protects the chuck 16. The nose piece housing 18 is generally cylindrical, and has a hollow interior bore 22 that extends through the length of the housing. The bore 22 has a cylindrical interior surface that is coaxial with the apparatus center axis 14. The interior surface of the bore 22 provides support to the drill bit chuck 16 for rotation of the chuck in the bore, and for axial movement of the chuck through the bore. The nose piece housing 18 is opened at its distal end 24 to enable insertion of a drill bit (not shown) into the opening and into the drill bit chuck 16 when removably securing the drill bit to the chuck.

The proximal end 26 of the nose piece housing 18 is connected to an air motor housing 28. The air motor housing 28 has a hollow interior bore 32 that extends through the air motor housing and is coaxial with the apparatus center axis 14. The air motor housing bore 32 communicates with the nose piece housing bore 22 through the connection between the air motor housing 28 and the nose piece housing 18. A slot (not shown) is provided through the side of the air motor housing 28 to the interior bore 32. The slot (not shown) extends axially along a portion of the length of the air motor housing bore 32.

An air motor 34 is mounted in the air motor housing bore 32 for axial reciprocating movement of the air motor through the bore. The air motor 34 is operatively connected with the drill bit chuck 16 by a shaft 36 of the motor, represented schematically in FIG. 1. The operative connection between the air motor 34 and the drill bit chuck 16 rotates the drill bit chuck in the nose piece housing bore 22 on operation of the air motor 34. The operative connection between the air motor 34 and the drill bit chuck 16 also causes the drill bit chuck 16 to reciprocate axially through the nose piece housing bore 22 on axial reciprocation of the air motor 34 in the air motor housing bore 32. The air motor 34 has an air pressure inlet 38 that extends through the air motor housing slot (not shown). The air pressure inlet 38 is connectable to a separate source of pneumatic pressure that is supplied to the air motor 34 to rotate the air motor shaft 36, as is conventional.

A linear actuator housing 42 is connected to the air motor housing 28. In the preferred embodiment of the invention, the linear actuator is a ball and lead screw linear actuator having a lead screw 44 that is operatively connected to the air motor 34, represented schematically in FIG. 1. The lead screw 44 and the linear actuator housing 42 are positioned coaxially with the apparatus center axis 14. Operation of the linear actuator lead screw 44 moves the air motor 34 axially through the air motor housing bore 32, and there moves the drill bit chuck 16 axially through the nose piece housing bore 22.

An electric motor 46 is connected to the linear actuator housing 42 to operate the lead screw 44 of the linear actuator. In the preferred embodiment, the electric motor 46 is a hybrid stepper motor having a rotational axis that is coaxial with the apparatus center axis 14. Selective operation of the electric motor 46 causes the lead screw 44 to move axially through the linear actuator housing 42, which in turn cause the air motor 34 to move axially through the air motor housing 28, which in turn causes the drill bit chuck 16 to move axially through the nose piece housing 18.

An encoder 52 is connected to the housing of the electric motor 46. In the preferred embodiment, the encoder 52 is an optical encoder. The encoder 52 monitors the rotary output of the electric motor 46 and produces signals representative of the degrees of rotation of the electric motor. The signals produced by the encoder 52 are also representative of the movements of the linear actuator 44 in the actuator housing 42, the movements of the air motor 34 in the air motor housing 28, and the movements of the drill bit chuck 16 in the nose piece housing 18. Thus, the encoder produces signals that are also representative of the axial position of a tip of a drill bit mounted in the drill bit chuck 16.

A sensor 54 is mounted on the side of the linear actuator housing 52 at a pre-determined position along the housing axial length. The sensor 52 is preferably a magnetic read switch. The lead screw 44 inside the linear actuator housing 42 is modified with a magnet (not shown), the position of which in the linear actuator housing 42 is sensed by the magnetic read switch sensor 54. Thereby, the sensor 54 senses the position of the linear actuator lead screw 44 in the actuator housing 42. In particular, the sensor 54 provides signals that are representative of the position of the lead screw 44 in the actuator housing 42, and thereby provides an indication of the movement of the lead screw 44 to its fully set back position in the linear actuator housing 42.

The stepper electric motor 46, the optical encoder 52, and the magnetic read switch 54 are all wired through flexible electrical conductors 56 to a programmable controller 58. The programmable controller 58 is wired to a separate power source 62. In the preferred embodiment, the power source 62 is a 30-volt, 4 amp power supply.

The controller 58 is programmable by connecting the controller to the serial port on a desktop computer (not shown). In the preferred embodiment the desktop computer would be running Si programmer software. A user of the apparatus writes a program using the desktop computer for the required motion profile of the apparatus, downloads the program to the controller 58, tests the program, and then removes the power and disconnects the controller from the desktop computer. Activating the controller 58 will then automatically run the downloaded motion profile. The program for the motion profile can be written so that the controller 58 requires only the press of an activation button to start the motion profile. This would allow the operator of the apparatus to lock the apparatus into a drilling fixture prior to starting the drilling cycle. The controller 58 could also be programmed to stop at any point when an “interrupt” button is pressed. This gives the production operator full control over when the motion profile starts, and also provides the operator with the ability to stop the drilling cycle if something goes wrong.

The controller 58 is also programmed to go to the start position should the linear motion of the actuator 42 encounter more than a predetermined rated load. This is very useful for situations where a drill bit becomes broken during the process, and accumulation of material chips hinders the rotation of the drill bit, or the air motor 34 is not rotating as the drill bit chuck 16 is fed forward by the linear actuator 42. As a result, even though the linear actuator 42 uses a mechanical lead screw, it is very difficult for anything to occur that would cause permanent damage to the actuator.

A separate programmable controller communicates with the electric motor, the optical encoder, and the sensor on the actuator housing. The controller is operative to control the operation of the electric motor based on information previously programmed into the controller and information provided by the signals produced by the optical encoder and the sensor. The programmable controller is designed so that a motion profile for the drilling operation to be performed by the apparatus can be programmed on a desk top computer and downloaded to the controller. The controller can then be activated by a push button operated by an individual monitoring the drilling operation of the apparatus. With the apparatus secured at a work station adjacent the object to be drilled, the operator activates the apparatus to execute a peck feed drill cycle or a drill/countersink cycle, according to the preprogrammed motion profile. The controller executes the motion profile by controlling the rotation of the air motor and electric motor, and the resulting rotation of the drill bit chuck and the linear movements of the linear actuator. The controller can execute the motion profile without being connected to an external computer, and the motion profile can be repeated any number of times desired as programmed. Exact feed rates, peck rates, set back distances, stroke lengths, and dwell times can be programmed into the motion profile programmed in the controller, and the controller will control the drilling cycle to repeat itself exactly time after time. The programmed motion profile cannot be changed by the operator, and crib setup personnel simply download the motion profile provided to them into the controller to control the operation of the apparatus. Thus, the apparatus of the invention provides very little chance for human or mechanical errors to occur in the drilling procedures.

The present invention greatly simplifies and improves the reliability of existing peck feed drilling and drill/countersink processes, and makes these processes more practical at manufacturing sights. The present invention provides significant improvements in the cost of manufacturing, the quality of the manufactured product, and the cycle time required for the manufacturing process. Thus, the apparatus of the invention represents an important evolutionary development in the field of portable power feed drilling.

1) A portable drill apparatus comprising:
a drill bit chuck that is adjustable to removably hold a drill bit;
an air motor having an air pressure inlet and having an axis of rotation that defines an axial direction relative to the air motor, the air motor being operatively connected to the chuck for selectively rotating the chuck about the axis of rotation in response to a selective supply of air pressure to the air pressure inlet;
a linear actuator operatively connected to the air motor and being operative to move the air motor axially along the air motor axis of rotation on operation of the linear actuator; and,
an electric motor operatively connected to the linear actuator to selective operate the linear actuator in response to selective operation of the electric motor.

2) The apparatus of claim 1, further comprising:
the chuck, the air motor, the linear actuator, and the electric motor all being arranged along the air motor axis of rotation.

3) The apparatus of claim 1, further comprising:
a nosepiece housing having a hollow interior bore with a center axis that is coaxial with the air motor axis of rotation; and,
the chuck being mounted in the nosepiece housing bore for axial reciprocating movement and rotary movement of the chuck in the nosepiece housing bore.

4) The apparatus of claim 3, further comprising:
an air motor housing having a hollow interior bore with a center axis, the air motor housing being connected to the nosepiece with the air motor housing axis being coaxial with the nosepiece housing axis; and,
the air motor being mounted in the air motor housing bore for axial reciprocating movement of the air motor in the air motor housing bore.

5) The apparatus of claim 1, further comprising:
a sensor mounted on the linear actuator and being operative to sense operation of the linear actuator and movement of the air motor.

6) The apparatus of claim 1, further comprising:
an encoder operatively connected to the electric motor and being operative to produce signals representative of movement of the air motor along the air motor axis of rotation.

7) The apparatus of claim 6, further comprising:
the chuck, the air motor, the linear actuator, the electric motor, and the encoder being arranged along the air motor axis of rotation.

8) The apparatus of claim 6, further comprising:
a programmable controller communicating with the electric motor and the encoder and being operative to control the operation of the electric motor.

9) The apparatus of claim 1, further comprising:
the linear actuator being a ball and lead screw actuator that converts rotary motion produced by the electric motor to linear axial movement of the air motor.

10) The apparatus of claim 9, further comprising:
the electric motor being a hybrid stepper motor.

11) A portable drill apparatus comprising:
a drill bit chuck that is adjustable to removably hold a drill bit;
a nosepiece housing having a hollow interior bore with a center axis that defines an axial direction relative to the nosepiece housing, the chuck being mounted in the nosepiece housing bore for axial reciprocating movement of the chuck in the nosepiece housing bore;
a first motor operatively connected to the chuck for rotating the chuck;
a first motor housing having a hollow interior bore with a center axis that is coaxial with the nosepiece housing center axis; the first motor housing being connected to the nosepiece housing, and the first motor being mounted in the first motor housing bore for axial reciprocating movement of the first motor in the first motor housing bore;
a linear actuator having an actuator housing connected to the first motor housing, the linear actuator being operatively connected to the first motor and the linear actuator being operative to move the first motor in the first motor housing bore in response to operation of the linear actuator; and,
a second motor connected to the linear actuator housing, the second motor being operatively connected to the linear actuator whereby the linear actuator converts a rotary output of the second motor into the axial reciprocating movement of the first motor.

12) The apparatus of claim 11, further comprising:
the nosepiece housing, the first motor housing, the actuator housing, and the second motor all being connected stationary to each other.

13) The apparatus of claim 12, further comprising:
the nosepiece housing, the first motor housing, the actuator housing, and the second motor all being aligned along the axial direction.

14) The apparatus of claim 11, further comprising:
a programmable controller; and,
a flexible electrical conductor communicating the programmable controller with the second motor and the linear actuator, the conductor enabling the nosepiece housing, the first motor housing, the actuator housing, and the second motor housing to be moved manually together relative to the programmable controller.

15) The apparatus of claim 14, further comprising:
a sensor mounted on the actuator housing, the sensor being operative to sense operation of the linear actuator; and,
the electrical conductor communicating the programmable controller with the sensor.

16) The apparatus of claim 14, further comprising:
an encoder mounted on the second motor, the encoder being operative to produce signals representative of movement of the first motor in the first motor housing bore.

17) The apparatus of claim 16, further comprising:
the conductor communicating the programmable controller with the encoder.

18) The apparatus of claim 11, further comprising:
the linear actuator being a ball and lead screw linear actuator.

19) The apparatus of claim 11, further comprising:
the second motor being an electric hybrid stepper motor.

20) A portable drill apparatus comprising:
a drill bit chuck that is adjustable to removably hold a drill bit;
a nosepiece housing having a hollow interior bore with a center axis that defines an axial direction, the chuck being mounted in the nosepiece housing bore for axial reciprocating movement of the chuck in the nosepiece housing bore;
an air motor having an axis of rotation, the air motor being operatively connected to the chuck for rotating the chuck about the air motor axis of rotation,
an air motor housing having a hollow interior bore with a center axis that is coaxial with the nosepiece housing center axis, the air motor housing being connected to the nosepiece housing and the air motor being mounted in the air motor housing bore for axial reciprocating movement of the air motor in the air motor housing bore;
a linear actuator having an actuator housing connected to the air motor housing, the linear actuator being operatively connected to the air motor for reciprocating the air motor in the air motor housing bore;
an electric motor having an electric motor housing connected to the linear actuator housing, the electric motor being operatively connected to the linear actuator for causing the linear actuator to reciprocate the air motor in the air motor housing in response to operation of the electric motor;
an encoder having an encoder housing mounted on the electric motor housing, the encoder being operative to sense operation of the electric motor and to produce signals representative of the operation of the electric motor, representative of the operation of the linear actuator, and representative of the axial movement of the air motor in the air motor housing bore; and,
a programmable controller communicating with the electric motor and the encoder to control the axial movement of the air motor in the air motor housing bore.
